(19) United States
(12) Patent Application Publication
(10) Pub. No.: US 2009/0047471 A1
(43) Pub. Date: Feb. 19, 2009

(54) Fiber structure component, robot component, industrial robot, composite component in general, composite components for terrestrial or air and space vehicles, and manufacturing method for a fiber structure component

(75) Inventor: Otto Josef Kellenberger, Bainfurt (DE)

Correspondence Address: WOOD, HERRON & EVANS, LLP, 2700 CAREW TOWER, 441 VINE STREET, CINCINNATI, OH, 45202, US

(73) Assignee: Kuka Roboter GmbH, Augsburg (DE)

(21) Appl. No.: 12/190,732

(22) Filed: Aug. 13, 2008

(30) Foreign Application Priority Data
Aug. 17, 2007 (DE) 10 2007 038 926.6

(51) Int. Cl. B32B 3/10; B32B 37/12

(52) U.S. Cl. 428/138; 156/60

(57) ABSTRACT

The invention relates to a fiber structure component (1, 1′), a robot component, an industrial robot (2), a composite component in general, a composite assembly for land, air and space vehicles, and a manufacturing method for the fiber structure component (1, 1′). The fiber structure component (1, 1′) has at least one stiffening layer (13) to stiffen the fiber structure component (1, 1′) and at least one fiber layer (14) with fiber mats and a matrix, bonded to the stiffening layer (13). The stiffening layer (13) has at least one support element (4, 9), which is surrounded with a fiber material (12). The support element (4, 9) has holes (5) and/or openings (6) for permeation with the fiber material (12) and is provided with a profiling (7, 8). The support element (4, 9) is electrically conductive. In combination with the fiber layer it enhances the structural properties (mechanical structure, stiffness, self-resonant frequency, as well as the electrical conductivity and electrostatic property with regard to electromagnetic compatibility).

The invention relates to a fiber structure component, robot component, industrial robot, composite component, and manufacturing method for a fiber structure component.

Fiber structure components are known in various areas of application, for example vehicle construction and aerospace, and are used to realize structural elements and component combinations in both simple and complicated form; in contrast to other components with the same strength, they are simple to realize and have low weight. Fiber structure components are made from fiber composite materials, which consist for example of a fabric of synthetic fibers, for example carbon fibers, and a matrix, for example a curable synthetic resin. In addition they can have stiffening elements, for example in the form of metal inserts. To improve and enhance a contact surface between the metal and synthetic layers and to increase the level of bonding of the layers, metal fibers are applied to the sheets, for example by soldering and/or sintering.

Industrial robots are handling machines that are equipped for automatic handling and processing of objects with appropriate tools, for example as a type of hand or so-called central hand, and that are programmable in a plurality of axes of motion, at least in two axes, in particular with regard to orientation, position and operating sequence. Examples of robot parts here are robot arms, bases, flanges and end effectors. End effectors are all operating resources or structures that are assigned to a robot for handling. DE 199 09 675 A1 describes a layered structure and a method for producing it. The layered structure has at least one layer made of fiber-reinforced synthetic material, and a cover layer that has metal fibers and/or threads adjacent to the fiber-reinforced synthetic material layer, where the fiber-reinforced synthetic material layer and the metal fibers and/or threads are impregnated with a binding agent, and where the cover layer has a sheet bonded to the metal fibers and/or threads as its outer surface, at least in some areas.

DE 101 24 023 C1 describes a fiber-reinforced synthetic material part, such as a synthetic fiber reinforced robot arm, with a function element. A fiber-reinforced synthetic material element is provided, in which a plurality of metal parts reach through at least one fiber-reinforced extension.

DE 31 44 653 A1 describes a fiber composite construction that offers lightning and electromagnetic protection, for example on an aircraft. The outer surface layer of the fiber composite material is made of threads wrapped with conductive metal. The threads can be made of a composite material, glass for example, with an aluminum encasure, with the structure being woven or braided and mixed with resin. The metal-wrapped threads are cured simultaneously with the total construction of thread composite material.

These methods are relatively cost-intensive and relatively complicated. While it is true that the material stiffness and adhesive strength are improved, they may not always be adequate for heavy demands.

The object of the invention is to specify a fiber structure component that exhibits elevated material stiffness, improved material resonant frequency, and better electrical conductivity.

An additional object of the invention is to specify a corresponding robot component and an industrial robot having such a robot component.

A further object consists in specifying a composite assembly with at least one fiber structure component for a land, air or space vehicle.

The problem of the invention is solved by a fiber structure component having:

at least one stiffening layer to stiffen the fiber structure component, where the stiffening layer has at least one support element that is surrounded with a fiber material, and
at least one fiber layer bonded to the stiffening layer, having fiber mats and a matrix,
where the support element has holes and/or openings for permeation with the fiber material and is provided with a profiling. The support element is shaped from metal material and/or from electrically conductive polymer material (referred to hereinafter as PM),
and provides for a geometrically designed profiling. PMs (polymer materials) are electrically conductive. PMs can be executed as thermoplastics or thermoplastics of any polymeric type with high inherent stability.

The problem of the invention is also solved by a robot component having such a fiber structure component, an industrial robot having the robot component, and a composite component having the fiber component described above for a land, air or space vehicle.

Furthermore, the problem is solved by a method for producing a fiber structure component having the following procedural steps:

(V1) preparing a semi-finished material with holes and/or openings; semi-finished fabric materials (4, 9) may be used as an alternative; semi-finished materials are of metal and/or PM type, or meshes of these materials;
(V2) providing the semi-finished material with at least one profiling;
(V3) encasing the semi-finished material with a fiber material to make at least one stiffening layer, where the fiber material permeates the holes and/or openings or mesh; and
(V4) bonding the stiffening layer with at least one fiber layer and curing the latter to produce the fiber structure component.

The geometric form according to the invention, i.e., the profiling of the support element, which serves as stiffening in the design of the fiber structure component, greatly enhances the material properties, for example the tensile, compressive, torsional and bending strength. Moreover, the metal inclusions and PMs can improve the vibration properties of the end products under load, as well as their electrical and electromagnetic properties with regard to electromagnetic compatibility regulations. The metal and/or PM layers can result in better electrical conductivity in order to reduce low-current and heavy-current shock, as well as creating improved grounding with regard to electrostatic properties. In addition, the protective effect is improved through shielding and the completion of a faraday cage, for example in the case of land vehicles and aircraft.

A versatile fiber structure component for various intended uses is created, principally in robotics.

Employment in other areas is also possible, in particular in aerospace technology, as well as in other areas of industry, land vehicles, sports, and also in medical technology.

In one version the support element is a perforated semi-finished material of sheet material and/or a semi-finished fabric material (4, 9) with openings of various widths. These semi-finished materials can be made of metal, light-weight metal, electrically conductive PM or a combination thereof. The holes and openings can be made together with the profilings in a stamping/bending machine when preparing the particular semi-finished material. The geometry and orientation of the holes and openings is determined by the load orientation in the end product.

The profiling of the support element has for example a trapezoidal, triangular or wave-like cross section, situated so that it runs in one direction or in various directions of the fiber structure component, depending on the requirements of the component. A geometry offset of two semi-finished materials or semi-finished fabric materials is possible in the profiling.

Various profilings can be provided, with the possibility also of using a design of smallest bending geometries through nanotechnology.

The fiber material and/or fiber layer can also be of electrically conductive design.

The at least one fiber layer can be made from fiber mats with a matrix, which may be produced separately or directly on the stiffening layer. The layers are joined in a curing process, for example with the application of heat and/or pressure.

For example, the fiber material can be sprayed onto the semi-finished material to encase it.

Examples of exemplary embodiments of the invention are depicted in the attached schematic drawings. The figures show the following:

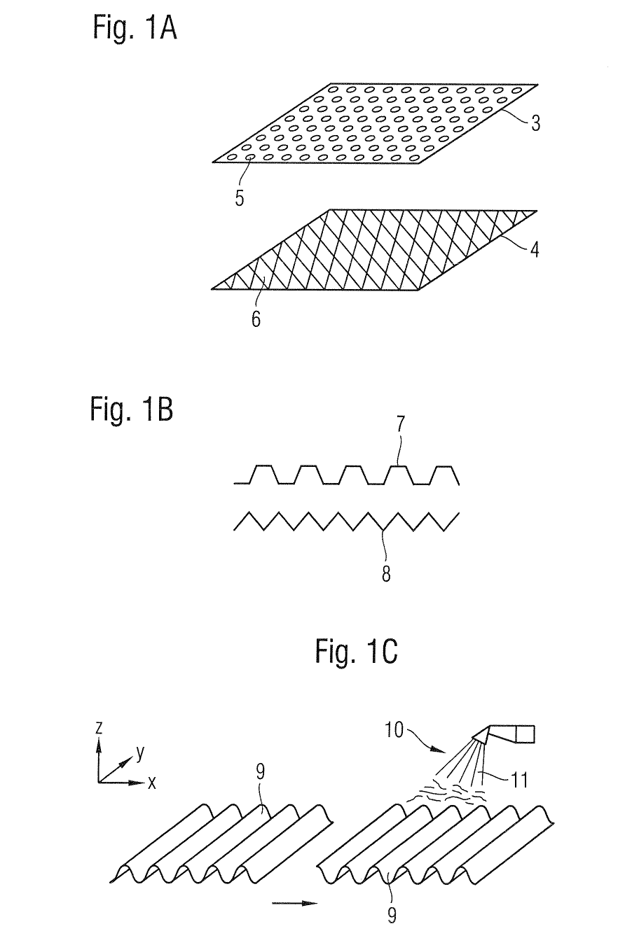

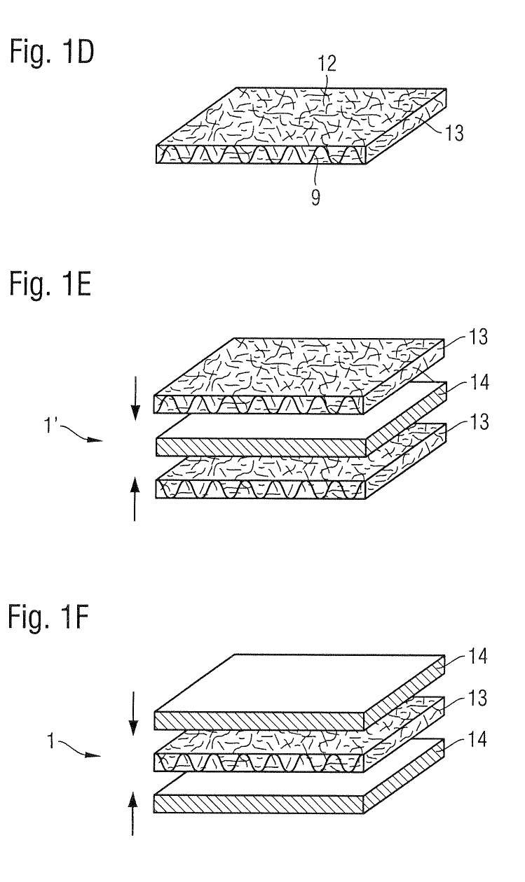

FIGS. 1A . . . F the production of a fiber structure component according to the invention;

FIG. 1A two semi-finished materials for that purpose;

FIG. 1B two exemplary profilings of the semi-finished materials in cross section;

FIG. 1C another profiling in perspective view, with a schematic depiction of a coating;

FIG. 1D a stiffening layer of the fiber structure component according to the invention;

FIG. 1E a combination for a first exemplary embodiment of the fiber structure component according to the invention;

FIG. 1F a combination for a second exemplary embodiment of the fiber structure component according to the invention;

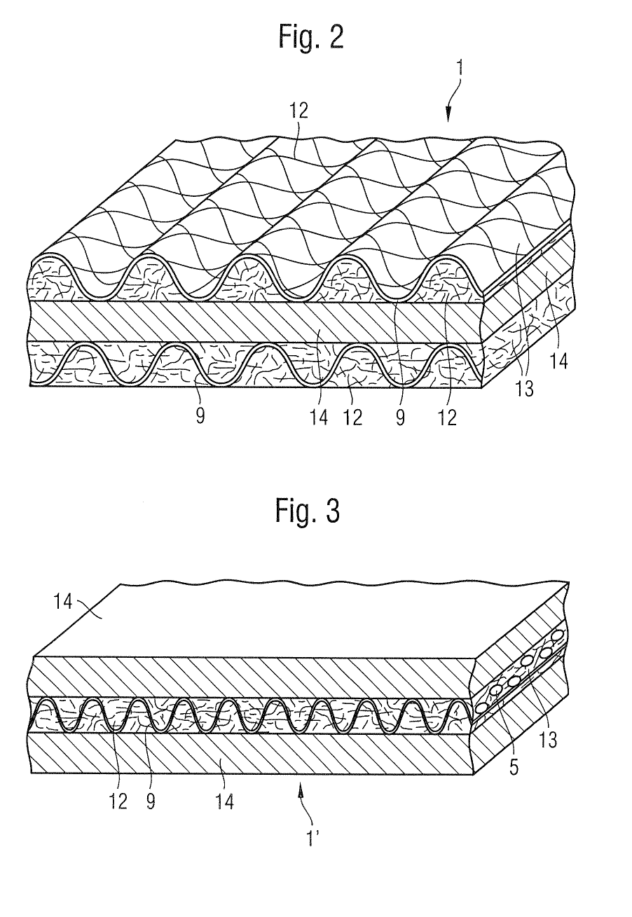

FIG. 2 the produced first exemplary embodiment according to FIG. 1E;

FIG. 3 the produced second exemplary embodiment according to FIG. 1F;

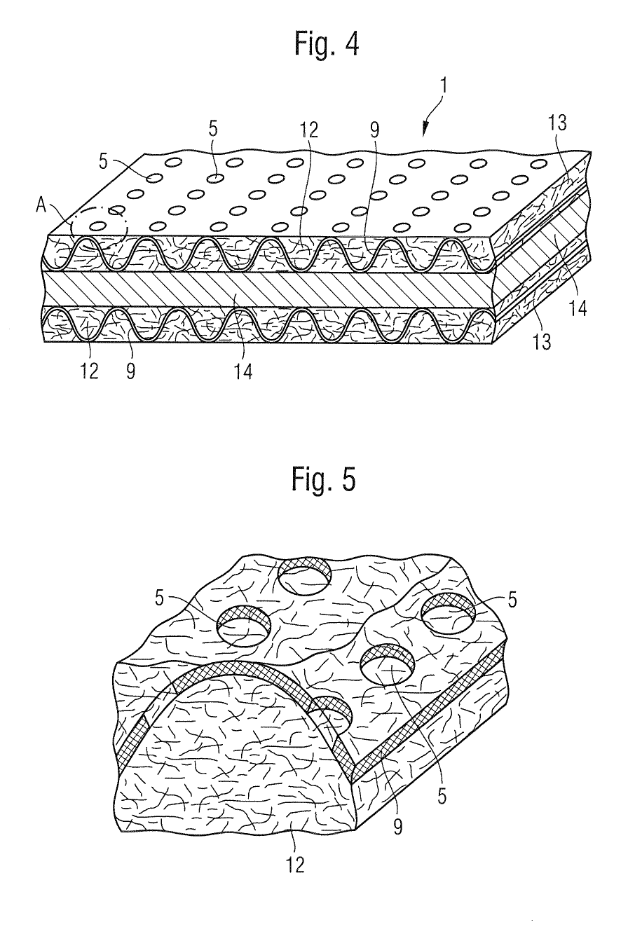

FIG. 4 the first exemplary embodiment according to FIG. 2 in a preferred version;

FIG. 5 an enlarged depiction of area A from FIG. 4;

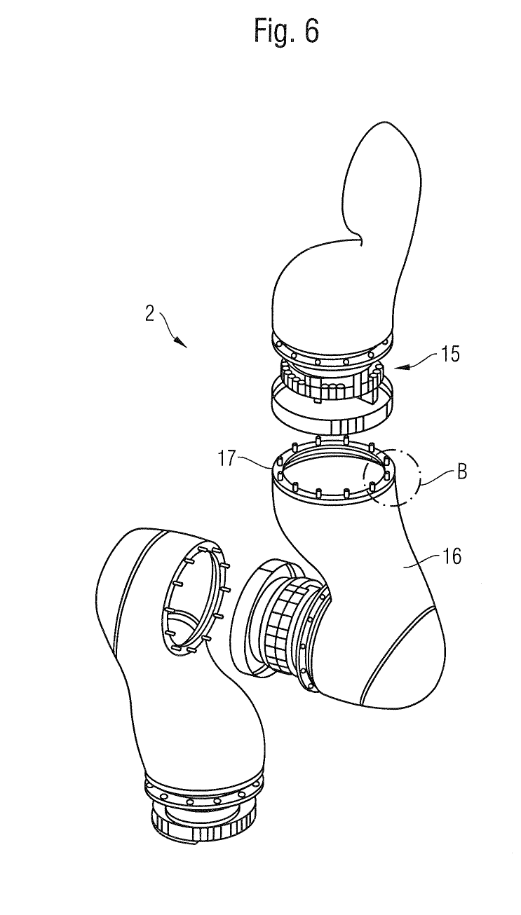

FIG. 6 an exemplary depiction of a portion of an industrial robot;

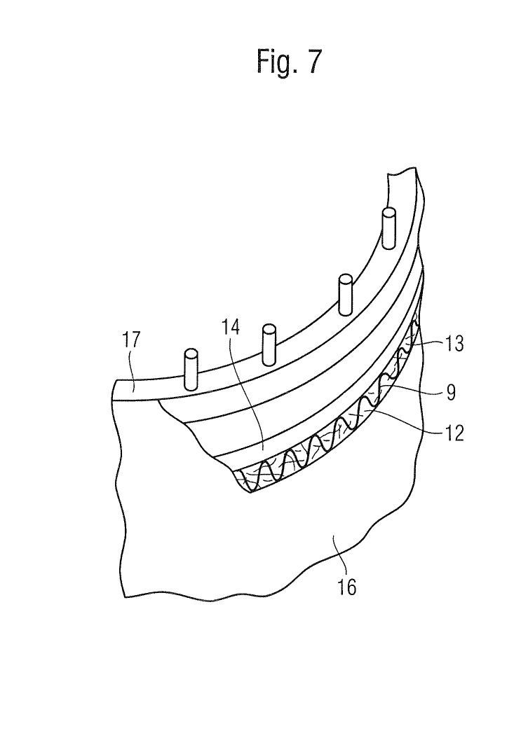

FIG. 7 an enlarged partial sectional view of area B from FIG. 6;

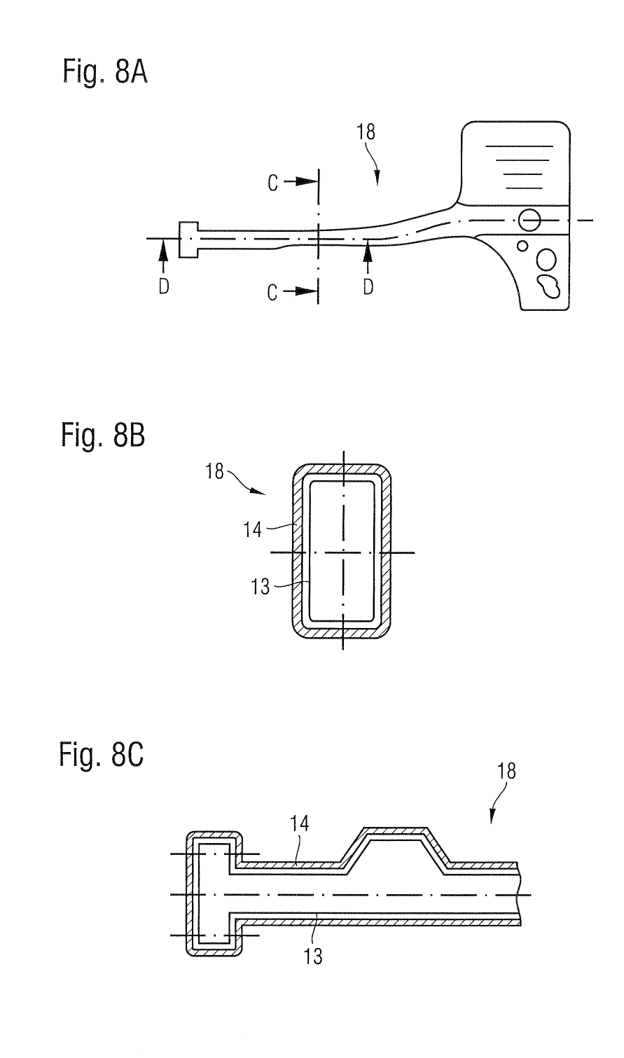

FIGS. 8A-C a schematic depiction of a composite component in two sectional views with another version of the fiber structure component according to the invention; and

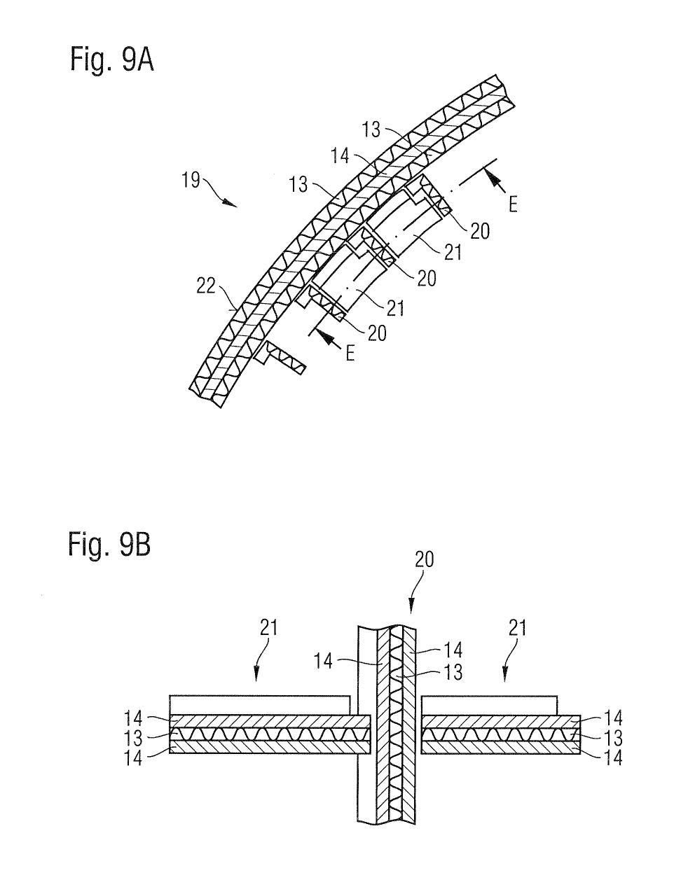

FIGS. 9A-B two sectional views of a composite component group with still additional versions of the fiber structure component according to the invention.

In the drawings, like components or components with the same function are given identical reference labels.

FIGS. 1A . . . F show steps of a production process for a fiber structure component 1, 1′ according to the invention (see FIGS. 2 though 5).

In a first step (FIG. 1A), a semi-finished material 3 or a semi-finished fabric material 4, 9 is cut to length or prepared as a coil. The semi-finished materials 3, 4 are provided with holes 5 and openings 6 (relatively wide meshes of the semi-finished fabric material 4, 9). The semi-finished material here is a thin sheet made of a metal, light-weight metal, PM or combination thereof. The semi-finished material 3 can also be prepared without holes 5, the holes 5 being added in a subsequent step.

In the following analysis only the semi-finished material 3 will be considered, with the following description also applying to the semi-finished fabric material 4, 9.

Semi-finished material 3 (FIG. 1B) is now provided with a profiling 7, 8, for example a trapezoidal first profiling 7 or a triangular second profiling 8. This can be done with an appropriate bending die in a bending or edging machine. The punching of the holes 5 can also be done on the same machine.

FIG. 1C shows the now profiled semi-finished material 3 as a support element 9 with another possible profiling in wave shape (together with trapezoidal, triangular or other geometric shapes). To provide better orientation for the following explanation, an x, y, z coordinate system will be specified here. The profiling here runs in the direction of a transverse axis y of support element 9. The profilings can also be introduced in the direction of a longitudinal axis x or at an angle thereto. Different profilings in different directions are also possible, while the extension in the z direction can also differ. This geometric forming is guided by the demand on the end component, which is defined by the fiber structure component 1, 1′ (see FIGS. 2 through 5). This geometric shaping significantly determines the later structural strength of the fiber structure component 1, 1′ (see FIGS. 2 through 5).

Using nanotechnology makes it possible to shape minimum bending geometries, which can result in a flexible layer thickness or height.

Both sides of support element 9 are provided with a coating means 10, for example in a stream 11 in a high-pressure spray-on process shown here schematically, so that support element 9 is encased here by the coating material 10 in the form of a (short or long) fiber material 12 in FIG. 1D. This will be described in further detail later in connection with FIGS. 2 through 5.

FIG. 1D shows the encased support element 9 as a stiffening layer 13 with a homogeneous layer of fiber material 12 on the top and bottom.

This stiffening layer 13 is combined with fiber layers 14 into a first version (FIG. 1E) and a second version (FIG. 1F) of the fiber structure component 1, 1′. In the first version the fiber layer 14 is surrounded by two stiffening layers 13, whereas in the second version the stiffening layer 13 is covered by two fiber layers 14. The number and arrangement of the layers are determined by the geometry and structural strength of the workpiece being shaped.

Fiber layer 14 can be produced separately as a synthetic fiber mat impregnated with a matrix, for example with a partially cured matrix, and then combined with stiffening layer 13 in a final curing process.

It is also possible for fiber layer 14 to be created on stiffening layer 13 in the “wet” state by applying fiber mats with matrix.

The methods for pre-curing and final curing, as well as for building up fiber layer 14, are known and will not be explained in further detail here.

A first version of a fiber structure component 1 completed in this way is shown in FIG. 2 in a schematic perspective view. Two support elements 9 are completely encased by fiber material 12 and form two stiffening layers 13, which cover fiber layer 14 and are bonded to it.

FIG. 3 shows the completed fiber structure component 1′ in a second version similar to FIG. 2. In contrast to the first version according to FIG. 2, a support element 9 completely encased in fiber material 12, as a stiffening layer 13 is covered by two fiber layers 14 and bonded with them.

As mentioned earlier, support element 9 is provided with holes 5 or openings 6. To explain the function of the holes 5 or openings 6, FIG. 4 shows a partial section of the first version of fiber structure component 1 according to the invention, with the holes 5 indicated on the depicted top stiffening layer 13. An area A is circled and shown enlarged in FIG. 5. The fiber material 12, which encases supporting element 9, permeates all the holes 5 of support element 9 (or all the openings 6 of a support element 9 made of a semi-finished fabric material 4, 9), and thus creates an advantageous intimate bond between fiber material 12 and support element 9. Fibers of the fiber material 12 are indicated schematically in FIGS. 4 and 5. These fibers likewise permeate the holes 5 or openings 6 and reinforce the bonding strength of stiffening layer 13.

These fiber structure components, produced as described above and structured in this way, are of course not only realizable in the flat construction depicted by way of example, but with suitable shaping tools can exhibit many different forms, some of which will be shown below.

In this connection FIG. 6 shows an exemplary exploded view of a portion of an industrial robot 2 with robot components, for example a robot arm 16, which is flexibly connected to other robot components. A swivel joint 15 of this sort is connected to robot arm 16 through a suitable flange 17. In this example robot arm 16 is constructed of a fiber structure component produced as described above, its relatively complex shape having a number of different roundings and hollows. An area B is shown in FIG. 7 in an enlarged partial sectional view. The outer skin of robot arm 16 is formed here by stiffening layer 13 with fiber material 12. Toward the interior of robot arm 16, stiffening layer 14 is provided with one or more fiber layers 13.

In industrial robots 2 like that shown in FIG. 6, drives and control elements are frequently situated inside the swivel joints 15. Here the stiffening layer 14 with its metal support element 9 forms a metallic encasure, which is electrically conductive and is bonded to the metal components flange 17 and swivel joint 15. In so doing, on the one hand it increases shielding in terms of electromagnetic compatibility and on the other hand forms a grounding possibility to prevent electrostatic charges. At the same time the material frequency resonance is improved.

Another application of a fiber structure component in the form of a composite component 18, for example a supporting element of an automobile, is shown in FIG. 8A. FIGS. 8B and 8C depict different cross sections according to cutting lines C-C and D-D in FIG. 8A. In this example a stiffening layer 13 is situated on the inside and a fiber layer 14 on the outside. The type and direction of profiling of stiffening layer 13 can be adapted to the loads and load directions acting on composite component 18, as mentioned earlier.

Designing safety-relative components in the automobile industry (for example side rails and/or base frames) using the fiber structure components achieves increased force and energy absorption, for example in crush and crumple zones, and a weight reduction.

FIGS. 9A and 9B show an exemplary application for an aircraft in two partial sectional views of a composite component group 19 with versions of the fiber structure component.

FIG. 9A shows a wall element 22 of an aircraft with pertinent stiffening elements 20, also referred to as longitudinal stringers, and a portion of a frame element 21. The construction of wall element 22 corresponds to the second version of the fiber structure component according to FIGS. 1F, 2 and 4. Outer and inner stiffening layers 13 enclose a fiber layer 14. Wall element 22 is stiffened in its interior in the radial direction by a frame element 21, and in the axial direction (perpendicular to the plane of the drawing) by stiffening elements 20. In this example, as shown in FIG. 9B as a section along cutting line E-E in Figure A, the stiffening elements 20 and the frame element 21 are designed as fiber structure components in the first version according to FIGS. 1E and 3, each having a stiffening layer 13 lying between two fiber layers 14 situated on the outside. The stiffening layers 13 are electrically connected to each other, and their electrical conductivity improves the electromagnetic behavior of the aircraft.

The fiber structure components can be used for both body and wing parts of an aircraft or space vehicle. Layers situated on the outside can have hollows during production (or be indented—similar to a golf ball) in order to prevent eddies, and thus reduce the air resistance of an aircraft. The high material strength and stiffness reduces the external skin thickness of an aircraft body, which results in a weight reduction.

The arrangement 1 according to the invention is not limited to the versions described and depicted in the figures. Modifications and changes are possible within the framework of the attached claims.

The fiber material 12 and/or the material of the fiber layers can be a conductive synthetic (polymer materials, also known as PMs).

Profilings 7, 8 other than those described as examples can be used, such as many-sided forms and combinations of the forms shown.

1. Fiber structure component (1, 1′), having:
at least one stiffening layer (13) to stiffen the fiber structure component (1, 1′), the stiffening layer (13) having at least one metal support element and/or being made of polymer materials (PMs) (4, 9), which is surrounded by a fiber material (12); and
at least one fiber layer (14) with fiber mats and a matrix, bonded to the stiffening layer (13), the metal or PM support element (4, 9) having holes (5) and/or openings (6) for permeation with the fiber material (12) and being provided with a profiling (7, 8).

2. Fiber structure component (1, 1′) according to claim 1,
wherein the support element (4, 9) is a perforated semi-finished material (3) of sheet and/or a semi-finished fabric material (4, 9) with openings (6).

3. Fiber structure component (1, 1′) according to claim 2,
wherein the support element (4, 9) is made of metal, light-weight metal, polymer materials or a combination thereof.

4. Fiber structure component (1, 1′) according to one of claims 1 through 3,
wherein the profiling (7, 8) of the support element (4, 9) is situated so that it runs in one direction or various directions of the fiber structure component (1, 1′).

5. Fiber structure component (1, 1′) according to one of claims 1 through 4,
wherein the support element (4, 9) has various profilings (7, 8).

6. Fiber structure component (1, 1′) according to one of claims 1 through 5,
wherein the fiber material (12) and/or the fiber layer (14) is of electrically conductive design.

7. Robot component having a fiber structure component (1, 1′) according to one of claims 1 through 6 for an industrial robot (2).

8. Industrial robot (2) having a fiber structure component (1, 1′) according to one of claims 1 through 6,

9. Composite assembly (19) having at least one fiber structure component (1, 1′) according to one of claims 1 through 6 for a land, air or space vehicle and components from other areas of industry.

10. Method for producing a fiber structure component (1, 1′), having the following process steps:
(V1) preparing a semi-finished material of metal and/or polymer materials (3, 4, 9) with holes (5) and/or openings (6);
(V2) providing the semi-finished material or semi-finished fabric material (3, 4, 9) with at least one profiling (7, 8);
(V3) encasing the semi-finished material or semi-finished fabric material (3, 4, 9) with a fiber material (12) to make at least one stiffening layer (13), where the fiber material (12) permeates the holes (5) and/or openings (6); and
(V4) bonding the stiffening layer (13) with at least one fiber layer (14) and curing it to produce the fiber structure component (1, 1′).

11. Method according to claim 10,
wherein the semi-finished material (3, 4, 9) is made of metal or polymer materials and is simultaneously provided with the holes (5) and/or openings (6) and the profilings (7, 8).

12. Method according to claim 10 or 11,
wherein the at least one fiber layer (14) is made from fiber mats with a matrix.

13. Method according to claim 12,
wherein the at least one fiber layer (14) is made separately, placed on the at least one stiffening layer (13) and bonded to the latter.

14. Method according to claim 12,
wherein the at least one fiber layer (14) is built up on the at least one stiffening layer (13) and bonded to the latter.

15. Method according to one of claims 10 through 14,
wherein the fiber material (12) is sprayed onto the semi-finished material (3, 4, 9) to encase it.
